(19) United States
(12) Patent Application Publication
(10) Pub. No.: US 2026/0086879 A1
(43) Pub. Date: Mar. 26, 2026

(54) GEOGRAPHIC DATA VISUALIZATION TECHNIQUES

(71) Applicant: SCHLUMBERGER TECHNOLOGY CORPORATION, Sugar Land, TX (US)

(72) Inventors: Aaron SCOLLARD, Houston, TX (US); Tracy DORRINGTON, Houston, TX (US); Ranadeep MUKHERJEE, Houston, TX (US); Steven LOUCKS, Houston, TX (US); Alagappan NARAYANAN, Houston, TX (US); Daniel ALVARADO, Houston, TX (US); Brandon VALTIERRA MAGOS, Houston, TX (US)

(21) Appl. No.: 19/113,001

(22) PCT Filed: Sep. 19, 2023
(86) PCT No.: PCT/US2023/074574

§ 371 Date: Mar. 19, 2025

Related U.S. Application Data
(60) Provisional application No. 63/376,231, filed on Sep. 19, 2022.

(51) Int. Cl. G06F 9/50

(52) U.S. Cl. CPC G06F 9/5077

(57) ABSTRACT

A method includes receiving, via one or more processors, resource data from a plurality of source. The method also includes determining, via the one or more processors, location data associated with the resource data from the plurality of sources. Further, the method includes receiving, via the one or more processors, criteria data corresponding to a user accessing the resource data. Further still, the method includes generating, via the one or more processors, a geographic data visualization of the resource data based on the location data. The geographic data visualization includes a plurality of visual resource representations indicative of at least a portion of the resource data.

### CROSS-REFERENCE TO RELATED APPLICATIONS

This application claims priority to U.S. Provisional Application No. 63/376,231, filed on Sep. 19, 2022, which is hereby incorporated in its entirety.

### INTRODUCTION

This disclosure relates generally to generating a geographic data visualization based on resource data and location data.

### BACKGROUND

Oil and gas enterprises may utilize resource data from a variety of sources, such as certain governments (e.g., local or national), the oil and gas enterprises' own resource data, and resource data acquired by other oil and gas enterprises. The resource data may span a variety of resources including schematics and energy usage of power plants, seismic data (e.g., two-dimensional (2D) seismic data, three-dimensional (3D) seismic data), well logs, renewable or alternative energy sources, and the like. In any case, the resource data can cover a broad range of sources and topics that may make it difficult for a user to analyze the resource data. As such, it may be advantageous to provide techniques that make it easier for the user to analyze the data.

This section is intended to introduce the reader to various aspects of art that may be related to various aspects of the present techniques, which are described and/or claimed below. This discussion is believed to be helpful in providing the reader with background information to facilitate a better understanding of the various aspects of this disclosure. Accordingly, it should be understood that these statements are to be read in this light, and not as admissions of prior art.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

One aspect of the present disclosure is directed to a method. The method includes receiving resource data from a plurality of sources. The method also includes determining location data associated with the resource data from the plurality of sources. Further, the method includes receiving criteria data corresponding to a user accessing the resource data. Further still, the method includes generating a geographic data visualization of the resource data based on the location data, wherein the geographic data visualization comprises a plurality of visual resource representations indicative of at least a portion of the resource data.

Another aspect of the present disclosure is directed to a method. The method includes receiving resource data from a plurality of sources. The method also includes determining location data associated with the resource data from the plurality of sources. Further, the method includes generating a geographic data visualization of the resource data based on the location data, wherein the geographic data visualization comprises a plurality of visual resource representations indicative of at least a portion of the resource data. Further still, the method includes receiving criteria data indicating a user accessing the geographic data visualization. Even further, the method includes determining one or more visual resource representations of the plurality of visual resource representations to display on the geographic data visualization based on the criteria data. Even further, the method includes updating the geographic data visualization based on the one or more visual resource representations of the plurality of visual resource representations.

Another aspect of the present is directed to a system that includes one or more processors and a non-transitory computer-readable medium comprising computer-executable instructions that, when executed, cause the one or more processors to perform operations including receiving resource data from a plurality of sources. The operations also include determining location data associated with the resource data from the plurality of sources. Further, the operations include receiving criteria data corresponding to a user accessing the resource data. Further still, the operations include generating a geographic data visualization of the resource data based on the location data, wherein the geographic data visualization comprises a plurality of visual resource representations indicative of at least a portion of the resource data.

Various refinements of the features noted above may be made in relation to various aspects of this disclosure. Further features may also be incorporated in these various aspects as well. These refinements and additional features may be made individually or in any combination. For instance, various features discussed below in relation to one or more of the illustrated embodiments may be incorporated into any of the above-described aspects of this disclosure alone or in any combination. The brief summary presented above is intended only to familiarize the reader with certain aspects and contexts of embodiments of this disclosure without limitation to the claimed subject matter.

For clarity and simplicity of description, not all combinations of elements provided in the aspects of the invention recited above have been set forth expressly. Notwithstanding this, the skilled person will directly and unambiguously recognize that unless it is not technically possible, or it is explicitly stated to the contrary, the consistory clauses referring to one aspect of the embodiments described herein are intended to apply mutatis mutandis as optional features of every other aspect of the invention to which those consistory clauses could possibly relate.

### BRIEF DESCRIPTION OF THE DRAWINGS

Various features, aspects, and advantages of this disclosure will become better understood when the following detailed description is read with reference to the accompanying figures in which like characters represent like parts throughout the figures, wherein:

FIG. 1 illustrates a schematic diagram of a data discovery and transformation system in communication with a database via a network, according to one or more embodiments of this disclosure;

FIG. 2 illustrates a block diagram of various components that may be part of the data discovery and transformation system, according to one or more embodiments of this disclosure;

FIG. 3 is a flow diagram of a first example method for generating a geographic data visualization, according to one or more embodiments of this disclosure;

FIG. 4 is a flow diagram of a second example method for generating the geographic data visualization, according to one or more embodiments of this disclosure;

FIG. 5 is a schematic diagram of software applications that may utilize the data discovery and transformation system, according to one or more embodiments of this disclosure;

FIG. 6 is a screenshot of a first example of the geographic data visualization, according to one or more embodiments of this disclosure;

FIG. 7 is a screenshot of a second example of the geographic data visualization, according to one or more embodiments of this disclosure;

FIG. 8 is a screenshot of a third example of the geographic data visualization, according to one or more embodiments of this disclosure;

FIG. 9 is a screenshot of a fourth example of the geographic data visualization, according to one or more embodiments of this disclosure; and

FIG. 10 is a screenshot of a fifth example of the geographic data visualization, according to one or more embodiments of this disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The drawing figures are not necessarily to scale. Certain features of the embodiments may be shown exaggerated in scale or in somewhat schematic form, and some details of conventional elements may not be shown in the interest of clarity and conciseness. Although one or more embodiments may be preferred, the embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to intimate that the scope of the disclosure, including the claims, is limited to that embodiment.

When introducing elements of various embodiments of this disclosure, the articles “a,” “an,” and “the” are intended to mean that there are one or more of the elements. The terms “including” and “having” are used in an open-ended fashion, and thus should be interpreted to mean “including, but not limited to . . . ” Any use of any form of the terms “couple,” or any other term describing an interaction between elements is intended to mean either an indirect or a direct interaction between the elements described.

Certain terms are used throughout the description and claims to refer to particular features or components. As one skilled in the art will appreciate, different persons may refer to the same feature or component by different names. This document does not intend to distinguish between components or features that differ in name but not function, unless specifically stated.

Reference throughout this specification to “one embodiment,” “an embodiment,” “embodiments,” “some embodiments,” “certain embodiments,” or similar language means that a particular feature, structure, or characteristic described in connection with the embodiment may be included in at least one embodiment of this disclosure. Thus, these phrases or similar language throughout this specification may, but do not necessarily, all refer to the same embodiment. Although this disclosure has been described with respect to specific details, it is not intended that such details should be regarded as limitations on the scope of this disclosure, except to the extent that they are included in the accompanying claims.

Additionally, the methods and processes described below may be performed by a processor. Moreover, the term “processor” should not be construed to limit the embodiments disclosed herein to any particular device type or system. The processor may include a computer system. The computer system may also include a computer processor (e.g., a microprocessor, microcontroller, digital signal processor, or general-purpose computer) for executing any of the methods and processes described below.

The computer system may further include a memory such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device.

Some of the methods and processes described below, can be implemented as computer program logic for use with the computer processor. The computer program logic may be embodied in various forms, including a source code form or a computer executable form. Source code may include a series of computer program instructions in a variety of programming languages (e.g., an object code, an assembly language, or a high-level language such as C, C++, or JAVA). Such computer instructions can be stored in a non-transitory computer readable medium (e.g., memory) and executed by the computer processor. The computer instructions may be distributed in any form as a removable storage medium with accompanying printed or electronic documentation (e.g., shrink wrapped software), preloaded with a computer system (e.g., on system ROM or fixed disk), or distributed from a server or electronic bulletin board over a communication system (e.g., the Internet or World Wide Web).

Alternatively or additionally, the processor may include discrete electronic components coupled to a printed circuit board, integrated circuitry (e.g., Application Specific Integrated Circuits (ASIC)), and/or programmable logic devices (e.g., a Field Programmable Gate Arrays (FPGA)). Any of the methods and processes described below can be implemented using such logic devices.

As mentioned above, oil and gas enterprises may utilize resource data from a variety of sources. As referred to herein, a “resource” refers to an asset (e.g., data, mathematical models, a machine component, and/or a software component) that may be utilized to inform oil and gas decisions, such as a drilling plan, how to efficiently transport materials (e.g., resources) to location, and the like. As referred to herein, “resource data” may include measurements, schematics, and other information associated with the resource. The resource data may include geologic data, non-geologic data, or both. The geologic data may include data corresponding to energy systems or equipment data corresponding to geologic features (e.g., tectonic locations, salinity information, geologic composition data), and/or well logging data (e.g., resistivity well logs, gamma-ray spectroscopy well logs, and other well logs). The non-geologic data may include infrastructure data (e.g., wind turbines, power plants, gas plants, oil refineries, pipelines, wells, transmission lines), data corresponding to business decisions (e.g., areas of interest for prospecting). In any case, the resource data may be stored in one or more databases (e.g., cloud storage), such that the resource data is readily accessible to a user. However, due to the large volume of the resource data, it may be difficult for a user to analyze the resource data in an efficient manner.

Accordingly, the present disclosure is directed to generating a geographic data visualization to enable users to more quickly find information by arranging resource data based on location data (e.g., geographic data) and controlling (e.g., focusing or limiting) the amount of displayed information associated with a geographic region. In general, generating the geographic data visualization may include organizing, indexing, categorizing, and generating a visualization of the resource data (e.g., graphical user interface on an electronic display), thereby transforming the resource based on location data and criteria data. As referred to herein, “location data” refers to data indicating a geographical or physical location associated with a resource (e.g., the GPS coordinates of a refinery). As referred to herein, “criteria data” refers to data indicating resources that a user and/or enterprise may desire to see or view. For example, the criteria data may be a location, a job title, a group within an enterprise, a type of resource currently processed by an enterprise, or otherwise identified information corresponding to a user viewing or requesting to view the geographic data visualization. In some instances, the criteria data may include search terms provided as input by the user. The geographic data visualization may illustrate, to a user, resource data and/or resource data collections (e.g., geologic data collections and/or non-geologic data collections) that are represented as areas located at (e.g., centered at) positions on the geographic data visualization. The resource collections may include combinations of the geologic data, combinations of the non-geologic data, or both, that may be predefined by certain criteria data, correspond to a representation (e.g., a model) associated with a geographic location (e.g., geographic area), or otherwise defined by a user. In any case, the geographic data visualization may display one or more resource data (e.g., individually or as one or more resource data collections) within a geographic region based on one or more criteria data (e.g., user criteria) indicating a type of resource data that may be more relevant to the user. Moreover, the geographic data visualization may enable a user to compare resource data collections to identify shared relationships and/or differences between the resource data associated with the resource data collections. In this way, generating the geographic data visualization that organizes and displays geologic data based on location data and/or criteria data may improve the efficiency of users managing and utilizing geologic data. For example, the geographic data visualization may enable users to efficiently collect resource data from their respective computing device, curate and refine the resource data into collections or datasets, discover or identify resource data, and utilize the data to improve oil and gas related decision making.

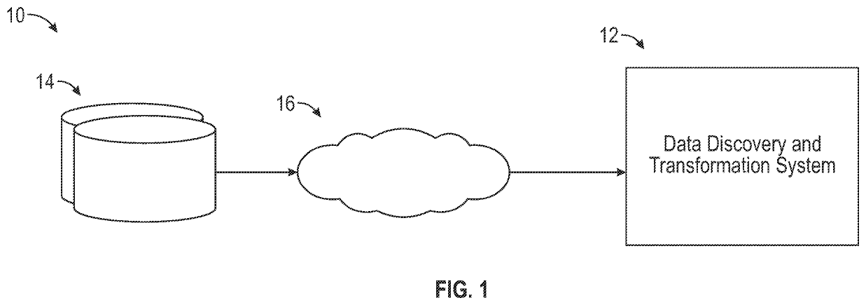

FIG. 1 illustrates a schematic diagram of a system 10 that includes a data discovery and transformation system 12 in communication with a database 14 via a network 16. In general, the database 14 may store resource data, such as geologic data and/or non-geologic data, from one or more sources, such as oil and gas enterprises, government agencies, etc. As discussed above, the geologic data may include data corresponding to geologic features (e.g., tectonic locations, salinity information, geologic composition data), data corresponding to business decisions (e.g., areas of interest for prospecting), and/or well logging data (e.g., resistivity well logs, gamma-ray spectroscopy well logs, and other well logs). In general, the geologic data may include any technical or non-technical data related to existing wells and/or potent future wells (e.g., oil and gas wells), including well locations, historical data for the wells, predictions for the wells, real-time data for the wells, relationships between wells, or any combination thereof. The non-geologic data may include data corresponding to energy systems or equipment (e.g., wind turbines, power plants, gas plants, oil refineries, pipelines, wells, transmission lines). For example, the non-geologic data may include schematic data for a gas plant, energy data (e.g., energy utilized by one or more buildings, an area, energy generated by energy sources such as power plant, renewable or alternative energy sources), infrastructure data, and the like. In any case, it may be desirable to utilize the data stored in the database 14 to inform oil and gas decisions. As described in further detail herein, the data discovery and transformation system 12 may retrieve the data stored in the database 14 and generate a geographic data visualization that enables a user to more efficiently parse the data (e.g., resource data, such as geologic data, well logging data, and/or data related to business decisions), thereby make decisions more rapidly. Moreover, the geographic data visualization may also be capable of selectively displaying certain types of resource data based on criteria data that indicates a relevance of the certain types of resource data. In this way, the disclosed techniques may manage computational resources for large volumes of data by adjusting an amount of resource data displayed on the geographic data visualization.

In general, the geographic data visualization may be an interactive map display that displays resource visualizations (e.g., visual resource representations) representing different resource data. The resource visualizations are displayed at positions (e.g., geographic coordinates) on the interactive map that correspond to geographic locations associated with the resource data. For example, the positions may correspond to latitude and longitude coordinates or global positioning system (GPS) coordinates. In some embodiments, the resource visualizations may provide a visual indication that identifies or corresponds a type of the resource data. For example, the data discovery and transformation system 12 may determine a number (e.g., two, three, four, five, six, eight, and so on) of categories (e.g., layers) corresponding to the resource data stored in the database 14. As such, the data discovery and transformation system 12 may assign each of the categories a different visual indication. In general, the visual indication may include a color, a pattern, a shape, or a combination thereof, to identify the type of resource data. In some embodiments, the geographic data visualization may include a legend to aid a user in identifying the resource data or resource type associated with the visual indication. Accordingly, a user viewing the interactive map may quickly determine an availability of resources in a particular area by visually inspecting a portion of the interactive map correspond to particular geographic location.

In some embodiments, the geographic data visualization may include one or more selectable or otherwise interactive features (e.g., a search bar, drop down arrows, check boxes, and the like) that a user may select or otherwise interact with, that adjusts the number of resource visualizations displayed on the interactive map. For example, the interactive map may include a search and filter window having one or more selectable features and/or interactive features that enable a user to tailor the amount and/or type of data displayed on the geographic data visualization.

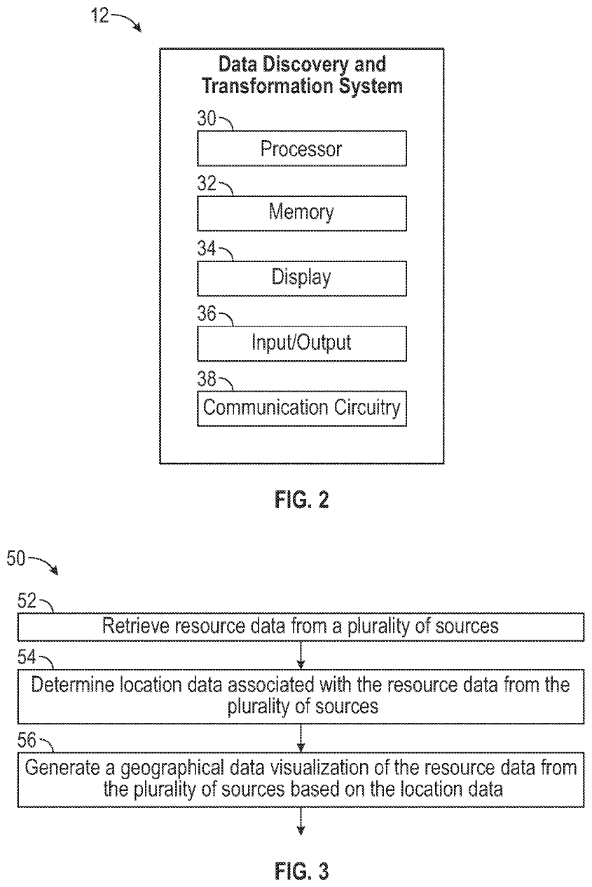

To perform the operations described herein, the data discovery and transformation system 12 may include one or more hardware elements (including circuitry), software elements (including machine-executable instructions) or a combination of both hardware and software elements (which may be referred to as logic). FIG. 2 is a block diagram illustrating the data discovery and transformation system 12, in accordance with aspects of the present disclosure. It should be noted that FIG. 2 is merely one example of a particular implementation and is intended to illustrate the types of components that may be present in the data discovery and transformation system 12.

The data discovery and transformation system 12 may include a processor 30, a memory 32, a display 34, input/output components (I/O) 36, and communication circuitry 38 to enable the data discovery and transformation system 12 to communicate with external storage components, such as cloud storage or the database 14. In some embodiments, the data discovery and transformation system 12 may store and/or execute an application in the memory 32 to be executed by the processor 40 that facilitates communication with the database 14. In some embodiments, the processor 30 may be one or more processors.

The communication circuitry 38 may include, for example, communication circuitry for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, long term evolution (LTE®) cellular network, long term evolution license assisted access (LTE-LAA) cellular network, 5th generation (5G) cellular network, and/or New Radio (NR) cellular network, a 6th generation (6G) or greater than 6G cellular network, a satellite network, a non-terrestrial network, and so on.

As described herein, the data discovery and transformation system 12 may be capable of generating a geographic data visualization that enable users to more quickly find information by arranging resource data based on location data (e.g., geographic data) and control (e.g., focus or limit) the amount of displayed information associated with a geographic region. With this in mind, FIG. 3 is a flow diagram of a first example method 50 for generating a geographic data visualization, according to one or more embodiments of this disclosure. In general, certain process blocks performed in the method 50 may be performed by the processor 30 of the data discovery and transformation system 12. Moreover, certain process blocks described below may be performed in a different order than that illustrated, and, indeed, in some embodiments, certain process blocks may be skipped altogether.

At block 52, the processor 30 retrieves, receives, or otherwise obtains resource data from a plurality of sources. As described herein, a “resource” refers to an asset (e.g., data, mathematical models, a machine component, and/or a software component) that may be utilized to inform oil and gas decisions, such as a drilling plan, how to efficiently transport materials (e.g., resources) to location, and the like. As referred to herein, “resource data” may include measurements, schematics, and other information associated with the resource. The resource data may include geologic data, non-geologic data, or both. The geologic data may include data corresponding to energy systems or equipment data corresponding to geologic features (e.g., tectonic locations, salinity information, geologic composition data), and/or well logging data (e.g., resistivity well logs, gamma-ray spectroscopy well logs, and other well logs). The non-geologic data may include infrastructure data (e.g., wind turbines, power plants, gas plants, oil refineries, pipelines, wells, transmission lines), data corresponding to business decisions (e.g., areas of interest for prospecting). In general, the resource data may be stored in a storage component, such as the database 14. Each of the resources data may include metadata, such as source identifier data that identifies information such as the enterprise that generated the resource data, a location data (e.g., geographical coordinates) that identifies the location corresponding the resource data (e.g., a geologic formation where a well-log was obtained, an area where a power plant is located, and the like).

At block 52, the processor 30 determines the location data (e.g., geographical coordinates) associated with the resource data from the plurality of sources. For example, the sources may be government sources, different enterprises, image data of natural formations stored in an accessible database. As such, the location data may be data indicating a physical location of the resource based on the resource. In general, the processor 30 may identify metadata indicating a location of the resources. For example, the metadata may include location data indicating geographical coordinates of a well, well site, seismic survey, field, basin, prospect, a power plant, a reservoir, a renewable or alternative energy source, and other resources as described herein. Further, the metadata may include timestamps that correlate the resource data to a particular time period. As such, the metadata may be useful for determining whether it may be desirable to update resource data based on available measurements acquired more recently.

Accordingly, at block 54, the processor 30 generates a geographic data visualization of the resource data 60 associated with the plurality of sources. In general, the processor 30 transforms the data using a location-based organization. In some embodiments, the geographic data visualization 68 may be an interactive map display that displays resource visualizations representing different resource data on a graphical user interface of an electronic display. The resource visualizations are displayed at positions on the interactive map that correspond to geographic locations associated with the resource data. In some embodiments, the resource visualizations may provide a visual indication that identifies or corresponds to a type of the resource data.

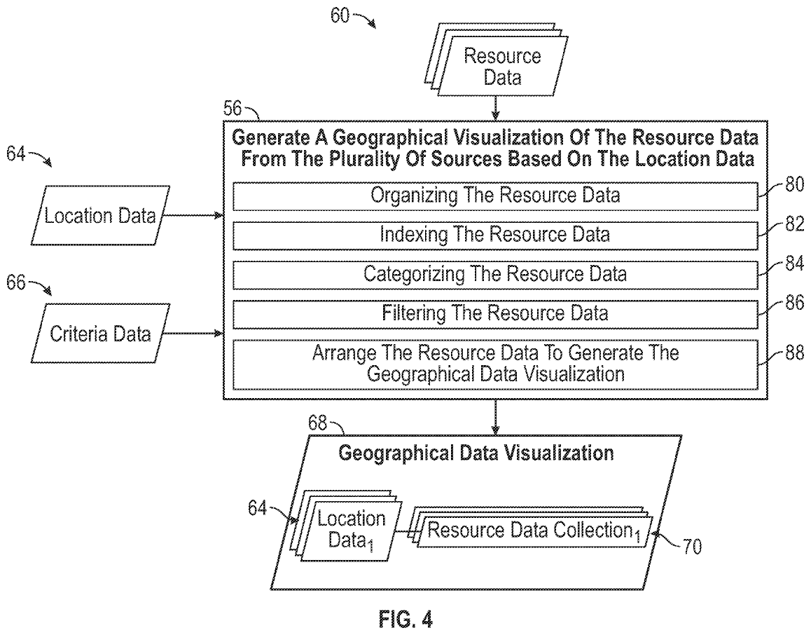

FIG. 4 is a flow diagram of a second example method for generating the geographic data visualization, according to one or more embodiments of this disclosure. In general, certain process blocks performed in block 56 of the method 50 may be performed by the processor 30 of the data discovery and transformation system 12. Moreover, certain process blocks described below may be performed in a different order than that illustrated, and, indeed, in some embodiments, certain process blocks may be skipped altogether. For example, the processor 30 may organize the resource data after categorizing the resource data. In some embodiments, the processor 30 may not filter and/or index the resource data 60.

In the general, the processor 30, at block 56 may receive the resource data 60, the location data 64 (e.g., determined at block 54 as described with respect to FIG. 3), and criteria data 66 to generate a geographic data visualization 68. In general, the criteria data 66 may include search terms, selected layers, ranking criteria, or other inputs that indicate resource types to display or not to display. In some embodiments, the criteria data 66 may include user-specific criteria, enterprise-specific criteria, or otherwise criteria that may indicate a desired use of the resource data 60 that may be used by the processor 30 to determine a particular subset of the resource data 60 that is relevant to an employee. For example, the user-specific criteria may include a role (e.g., job title, job position, or group within an enterprise) of a particular user accessing the resource data 60 or a visualization depicting the resource data 60. As another non-limiting example, the enterprise-specific data may include a location where the user works that may indicate the role of the user or a desired use of the data by the user. In any case, the processor 30 may utilize the criteria data 66 to determine a subset of the resource data to display on the geographic data visualization 68 that may be more relevant to the user. In this way, the criteria data 66 may be utilized by the processor 30 to reduce computational resources (e.g., memory resources and/or processing resources) associated with generating and/or displaying the geographic data visualization 68.

In some embodiments, the processor 30 may process the resource data 60. For example, the processor 30 may “flatten” or otherwise process the resource data 60 to extract relevant attributes that may be more desirable to view to a user. In general, flatten may refer to reducing the dimensions or size of the resource data 60. For example, the processor 30 may identify a depth range corresponding to a reservoir within well log data. Rather than storing the entirety of the resource data 60, the processor 30 may store only the portion related to the reservoir. In this way, the techniques of the present disclosure may manage computational resources dedicated to storing large volumes of data.

In some embodiments, flattening may involve computing summary information from the web of data and present the summary information to provide a business insight at a glance. For example, the processor 30 may determine answers to certain business-related queries, such as a number of gamma-ray (GR) logs in a well, whether a well has a preferred trajectory, whether the trajectory is qualified by a driller that may access the well, and so on. It should be noted that such information may otherwise only be obtainable through intimate knowledge of the resource corresponding to the resource data 60. As one specific non-limiting example, when the resource data 60 corresponds to one or more facilities, flattening the resource data 60 may include displaying producing or online events, such as an indication of a time period produces, the type of material produced or refined at the facility, an amount of material produced or refined at the facility, whether or not the facility has produced any material or otherwise operated within a time threshold (e.g., day(s), week(s), month(s), year(s)), or a combination thereof. In any case, the processor 30 may utilize historical data indicating previous queries related to the resource, and correlate that data with criteria data 66 to determine relevant queries and information related to the queries (e.g., answers) to present in the summary information.

In some embodiments, flattening may involve selecting a subset of attributes from a single list or searching through the hierarchy of related elements, to present the most useful information to the user. For example, the processor 30 may identify a relatively large number of attribute (e.g., 50+ attributes) in a well header/summary, and its related boreholes and trajectories. Accordingly, the processor 30 may determine a ranking criteria related to the attributes (e.g., ranking based on attributes users may attempt to access based on queries, how commonly used the attributes are amongst other attributes). In turn, the processor 30 may “flatten” the resource data 60 by presenting a small set (e.g., 2, 3, 4, 5, 6, 7, 8, 9, 10, or otherwise less than 50 as described in the example) of the attributes, rather than all of the attributes in the well/header summary.

At block 80, the processor 30 organizes the resource data 60. In general, the processor 30 organizing the resource data 60 may include organizing the resource data 60 with respect to relationships between the resource data 60. In general, the relationships may indicate whether different resource data 60 relate to the same location, or whether a resource may be useful for a type of infrastructure (e.g., a well having hydrocarbons may be relevant for power plants within a threshold range of 5 kilometers (km), 10 km, 15 km, 25 km, 50 km, or 100 km). That is, the processor 30 may determine that it is useful to relate certain resources based on a relevant score (e.g., threshold score) corresponding to, for example, proximity. In an embodiment where a first resource data 60 is an infrastructure and a second resource data 60 is a fuel source, the processor 30 may adjust the threshold range based on the presence of absence of transport features (e.g., railroads, accessible ports, and the like).

As another non-limiting example, the processor 30 may organize the resource data 60 using the location data, such type of resource such as well, well log, seismic, metadata such as source of the data, present of certain types of well logs available for a well etc., or a combination there-of. As one non-limiting example, the processor 30 may organize or arrange a well and its “related” attributes along with the geo-location as one Well Layer. In this example, the related attributes (e.g., categories) could be the presence of certain logs such as gamma ray logs, different interpretations/studies conducted on the well, research reports/evaluation reports/documents associated with a well, and so on.

In some embodiments, the relationships may include a temporal priority of the resource data 60. For example, a first resource data 60 may correspond to a first measurement (e.g., indicating an amount of available hydrocarbon fluids) of a location, and a second resource data 60 may correspond to a second measurement of the location at a time period after the first measurement was taken. As such, the second measurement may indicate a more recent or accurate amount of the available hydrocarbon fluids of the location. In some examples, different resource data 60 may be used to supplement or complement other resource data 60. For example, and continuing with the previous example, the second measurement may correspond to a different type of measurement than the first measurement. Further, the second measurement may be more accurate that the first measurement. As such, the resource data 60 corresponding to the second measurement may be used to refine the resource data 60 corresponding to the first measurement. Accordingly, and as described in further detail herein, a visual resource representation corresponding to the location associated with the first measurement and the second measurement may indicate one or both measurements. In this way, the visual resource representation may provide, at least in some instances, more accurate information as well as single, updated type of information (e.g., the amount of hydrocarbon fluids) that may be more readily discernable by the user as compared to displaying all of the resource data 60.

At block 82, the processor 30 indexes the resource data 60. In general, indexing the resource data 60 may include generating a copy of one or more records (e.g., rows) or columns (e.g., fields) of the resource data 60 to generally facilitate searching and retrieving the resource data 60, as understood by one of ordinary skill in the art. For example, the processor 30 may index a record corresponding to each attribute for a resource. For example, an index for a first resource data 60 may have a first field corresponding to the location of the first resource, a second field corresponding to gamma ray measurements related to the first resource, and a third field corresponding to evaluation reports of the first resource. Further, the index for the first resource data 60 may also include data from other sources, such identities of nearby refineries, power plants, or links to other resources that may be relevant to the resource. It should be noted that indexing may facilitate identifying resources that are related, such as having one or more shared attributes. For example, indexing may facilitate the processor 30, as well as users, to identify wells, refineries and gas plants with the same operator (e.g., are related based on the operator). As another non-limiting example, indexing may be useful to identifying seismic derivates related to a single seismic survey. In some embodiments, the processor 30 may index the resource data 60 by flattening the resource data 60.

At block 84, the processor 30 categorizes the resource data 60. In general, categorizing the resource data 60 may include determining one or more class and subclasses to represent the data. For example, the processor 30 may determine one or more classes and subclasses and each class and subclass may correspond to a resource type. As described in further detail herein, each resource type may be linked to a different layer is that is displayed on the geographic data visualization. For example, the categories may include wells, seismic 2D, seismic 3D, well logs, basins, fields, prospects, pipelines, power plants, refineries and so on. Each category may be further broken down into multiple subcategories. For example, a subcategory of a well may include horizontal wells, vertical wells, multilateral wells and so on. As an example, one category could be wells, and then subcategories could be plugged and abandoned, producing, injecting, gas, oil, condensate etc. that provide more granular information and/or further categorize the well. Wells may also have a sub category or attributes such as spud date, capacity or total cumulative production, types of produced fluids, geographical areas (e.g., countries, bodies of water, land areas, etc.), etc. Another example of a category may be refineries, which could then be broken down with subcategories (e.g., type of material produced by the refinery). Another category could be power plants. Another category could be Seismic Data which could be broken down into 2D, 3D and 4D. As described in further detail below, when a user accesses the resource data 60, the criteria data 66 indicating the user-specific data, enterprise-specific data, or otherwise, may be used to determine a subset of the resource data 60 to present to the user in a visual representation. The criteria data 66 may be pulled from a user upon the user accessing the geographic data visualization 68 (e.g., the processor 30 may access the criteria data 66 after or while a user accesses the geographic data visualization). As such, the processor 30 may utilize the criteria data 66 to determine a subset of the resource data to display as resource data visualizations that may be more relevant to the user, thereby tailoring the geographic data visualization 68 to the user and using less computational resources (e.g., memory resources and/or processing resources). For example, the processor 30 may determine whether two resource data 60 are related by determining a relevance score and comparing the relevance score to a threshold.

At block 86, the processor 30 filters the resource data 60. The processor 30 may determine whether any user preferences exist to not display or prioritize displaying certain resource types. For example, the processor 30 may determine whether a user has provided any criteria data 66 indicating resource data 60 that would be desirable to include or not include on the geographic data visualization.

In some embodiments, the processor 30 may filter the resource data 60 to generate an updated geographic data visualization. For example, the processor 30 may have previously generated a geographic data visualization 68 and, after receiving new criteria data 66, the processor 30 may update the geographic data visualization 68 to show a subset of visual representations.

As a non-limiting example of blocks 80, 82, 84, and 86, organizing the resource data 60 may include using the criteria data 66 indicating the user-specific data, enterprise-specific data, or otherwise, of a user accessing (or attempting to access) the resource data 60. For example, the processor 30 may determine that the criteria data 66 indicates that the user works for an enterprise that manages refineries for a particular type of material. As such, the processor 30 may filter the resource data 60 such that resource data 60 relevant to the user (e.g., refineries producing the type of material associated with the enterprise) remain, while irrelevant data is removed.

At block 88, the processor 30 arranges the resource data 60 to generate the geographic data visualization. In general, arranging the resource data 60 may include determining positions on an interactive map or other visualization to allocate to a particular resource or resource data 60. For example, the processor 30 may determine the resource data 60 to display based on ranking criteria, available space on the interactive map, criteria data 66, search terms provided on a search bar, selected layers, and the like, as described in further detail herein.

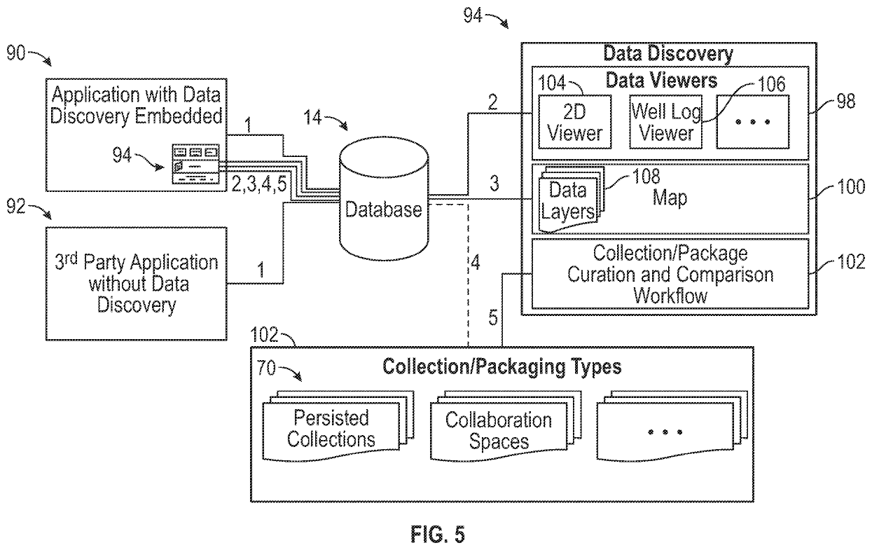

In some embodiments, the data discovery and transformation may be implemented by a software application being executed on a computing device. To illustrate this, FIG. 5 is a schematic diagram of software applications that may utilize the data discovery and transformation system, according to one or more embodiments of this disclosure, such as customer apps and vendor apps. As illustrated, an application 90 is executing the data discovery application 94 or plug-in associated with the data discovery and transformation system 12. The application 90 may access the resource data 60 stored in the database 14 using the data discovery application 94 or plug-in. Additionally, third party applications 92 may also access the database 14 via the data discovery application 94 or plug-in.

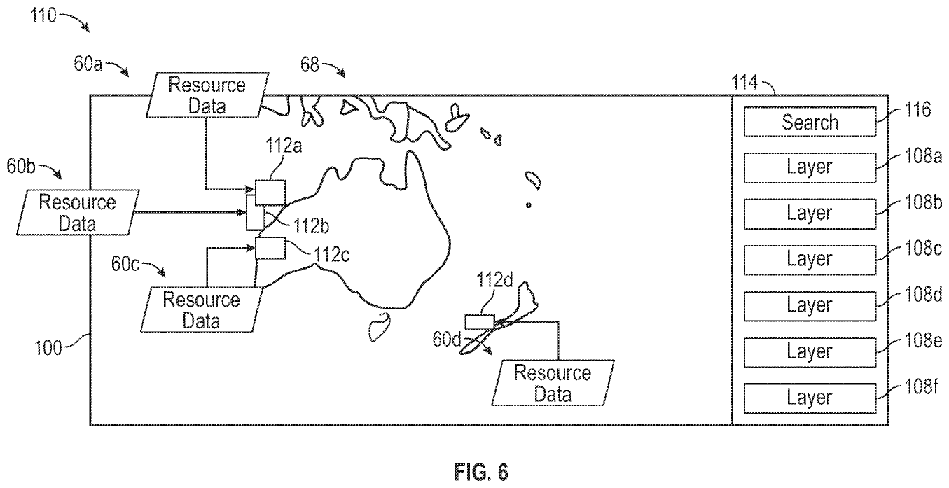

The data discovery application 94 may generate one or more visualizations based on the resource data 60. For example, the data discovery application 94 may generate data viewers 104 (e.g., domain data viewers) for displaying certain types of domain data visualizations, such as 2D data (e.g., 2D seismic data). As referred to herein, “domain data visualizations” refer to a particular type of software for viewing a type of data, domain, or both. For example, a seismic viewer may be a domain data visualization for “SEG Y” file type, a well log viewer may be a domain data visualization for a “LAS” file type, and a “wellbore schematic” or “document viewer” (e.g., PDF, .DOCX, and the like) may be a domain data visualization for well completion data. In this way, the data discovery application 94 may be capable of displaying different types of data, although each type of data may conventionally be displayed with a different type of visualization. Additionally, the data discovery application 94 may generate a well log viewer 106 for displaying well log data. The data discovery application 94 may also generate a map 100 (e.g., the interactive map) that includes multiple data layers 108. In general, the data layers 108 may correspond to different resource types of other categorization as described herein. Further, the data discovery application 94 may include a collection/packing curation and comparison workflow (CPCCW) 102. In general, the CPCCW 102 may include one or more user defined resource collections 70 or datasets. Although the illustrated embodiment describes OSDU TM data, it should be noted that the database 14 may be associated with other on prem or cloud data sources and systems maintained by the enterprises to hold energy data. Examples include commercial data management systems such as ProSource, EDM etc. in-house data management systems and data purchased from vendors such as Information Handling Services (IHS), Tomilson Geophysical Services (TGS) etc. As described herein, the geographic data visualization may illustrate, to a user, resource data 60 and/or resource data collections (e.g., geologic data collections and/or non-geologic data collections) that are represented as areas located at (e.g., centered at) positions on the geographic data visualization. FIG. 6 shows an interactive window 110 that includes a first example the geographic data visualization 68. As shown, the geographic data visualization 68 includes a first visual area 112a, a second visual area 112b, a third visual area 112c, and a fourth visual area 112d (e.g., collectively visual areas 112). In general, the visual areas 112 each correspond to a particular resource data 60, such as the first resource data 60a, the second resource data 60b, the third resource data 60c, and the further resource data 60d. As described herein, the resource collection 70 may include combinations of geologic data and/or non-geologic data. In general, the dimensions of the visualization areas 112 may be determined by the processor 30 based on a geographic area associated with the resource data 60 corresponding to the visualization area 112, a total dimension of the interaction window 110 and/or geographic data visualization 68, or a combination thereof. The visual areas 112 are generally visual indications of the resource data 60 to aid a user in identify resource types within a particular geographic location. As described herein, in some embodiments the visual indication may include a color, a pattern, a shape (e.g., an icon), or a combination thereof, to identify the type of resource data 60. In some embodiments, the visual indication may indicate a degree of relevance to a user based on the criteria data 66. For example, the processor 30 may determine a number of attributes or subcategories that are relevant to criteria data 66. In turn, the processor 30 may determine an alphabetic and/or numerical score (e.g., 1-100) corresponding to the relevance. For example, more relevant resource data 60 may be assigned a green visual indication, while less relevant resource data 60 may be assigned a yellow visual indication, while potentially irrelevant or irrelevant resource data 60 may be assigned a red visual indication. In this way, the geographic data visualization 68 may present colors that enable a user to quickly sort through large volumes of data using visual indications that guide a user to resource data 60 based on a determined relevance. As described herein, in some embodiments, the geographic data visualization may include a legend to aid a user in identify the resource data 60 or resource type associated with the visual indication. For example, the legend may indicate categories (e.g., a well) of the resource data 60, subcategories of the resource data 60 (e.g., producing well), and/or visual indications of relevant (e.g., green corresponds to ‘highly relevant’).

Additionally, the interactive window 110 includes a search and filter window 114. The search and filter window 114 includes one or more selectable features and/or interactive features that enable a user to tailor the amount and/or type of data displayed on the geographic data visualization 68. In the illustrated embodiment, the search and filter window 114 includes a search bar 116 and multiple data layers 108. In general, the search bar 116 may enable a user to input search terms to reduce the amount of data displayed on the geographic data visualization. In a generally similar manner, the data layers 108 are predefined or predetermined criteria that a user may desire to have displayed on the geographic data visualization 68. As shown, the search and filter window 114 includes a first data layer 108a, a second data layer 108b, a third data layer 108c, a fourth data layer 108d, a fifth data layer 108e, and a sixth data layer 108f. As described herein, each layer may correspond to a different category or subcategory associated with resource data 60. For example, the first data layer 108a may correspond to abandoned wells, and the second data layer 180b may correspond to producing wells. Further, each layer may be a selectable feature that, upon user selection, may cause a subset of resource visualizations to display or not be displayed on the geographic data visualization 68. Accordingly, the first data layer 108a and/or the second data layer 108b may be a selectable feature that enables a user to toggle visual resource representations displayed on the geographic data visualization 68. However, depending on various criteria, including the geographical area shown in the map 100, search criteria, etc., the number of data layers 108 may increase or decrease to any number.

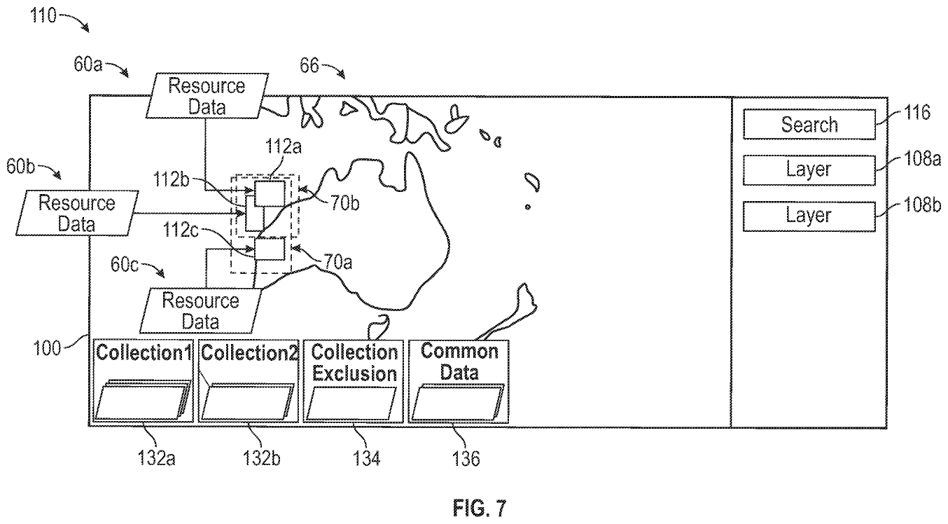

At least in some instances, it may be advantageous for a user to group one or more resource collections. For example, a user may desire to monitor a particular collection or refer back to a collection after a time period to monitor information associated with the resource. To illustrate this, FIG. 7 is an interactive window 110 that includes a second example the geographic data visualization 68. In this example, and referring to FIG. 6, a user may have selected the first data layer 108a and the second data layer 108b. Accordingly, the geographic data visualization 68 may only display resource data 60 that include data associated with the first data layer 108a and the second data layer 108b.

As shown, the interactive window 110 includes a first collection 70a (e.g., indicated by the visual resource collection representation or border in this example) that includes the first visual area 112a, the second visual area 112b, and the third visual area 112c. Additionally, the interactive window 110 includes a second collection 70b that includes the first visual area 112a, the second visual area 112b. The collections 70 may each be configured to enable a user to identify and monitor the resource data 60 associated with each collection 70. For example, upon receiving a selection (e.g., a user selection) of the first collection 70a, the interactive window 110 may display a collection card 132 that displays the resource data 60 corresponding to the selected first collection 70a. Similarly, upon receiving a selection of the second collection 70b, the interactive window 110 may display a collection card 132 that displays the resource data 60 corresponding to the selected second collection 70b.

At least in some instances, it may be desirable for a user to compare the resource data 60 associated with a particular collection 70. For example, a user may wish to account for a difference in production capabilities of a model utilizing the first collection 70a as compared to the second collection 70b. Accordingly, the collection 70 may also be configured to display an exclusion collection card 134 that displays resource data 60 that may be included in one collection, but not the other collection. Additionally or alternatively, the collection 70 may also be configured to display common resource data 60 between the first collection 70a and the second collection 70b. In this way, the geographic data visualization 68may enable a user to more efficiently monitor different resource collections.

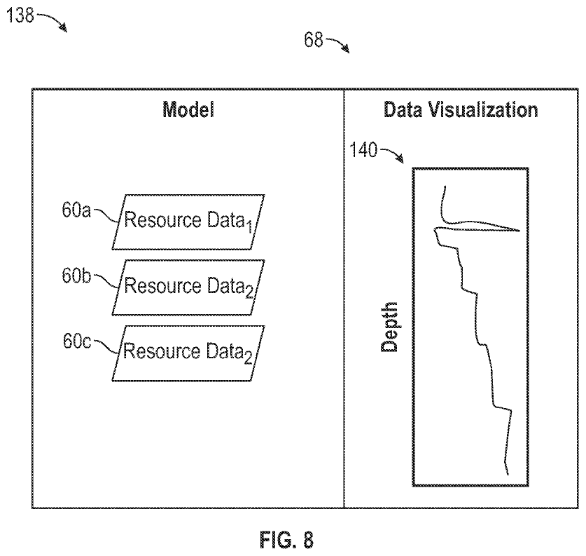

FIG. 8 is a screenshot of a third example the geographic data visualization, according to one or more embodiments of this disclosure. As described herein, resource collections 70 may include combinations of resource data 60, such as the geologic data, combinations of the non-geologic data, or both, that correspond to a representation (e.g., a model) associated with a geographic location (e.g., geographic area). Accordingly, the interactive window 138 may be displayed on the geographic data visualization 68 upon a user selecting a resource collection 70 and providing inputs to query the information associated with the resource. In this case, the geographic data visualization depicts a first resource 60a, a second resource 60b, and a third resource 60c and a corresponding well-log 104 that may be generated based on the first resource 60a, the second resource 60b, and the third resource 60c. In this way, the geographic data visualization 68 may enable a user to obtain more granular information about certain resources, such as well log data, as well as ascertain the resource data 60 used to generate the well log data.

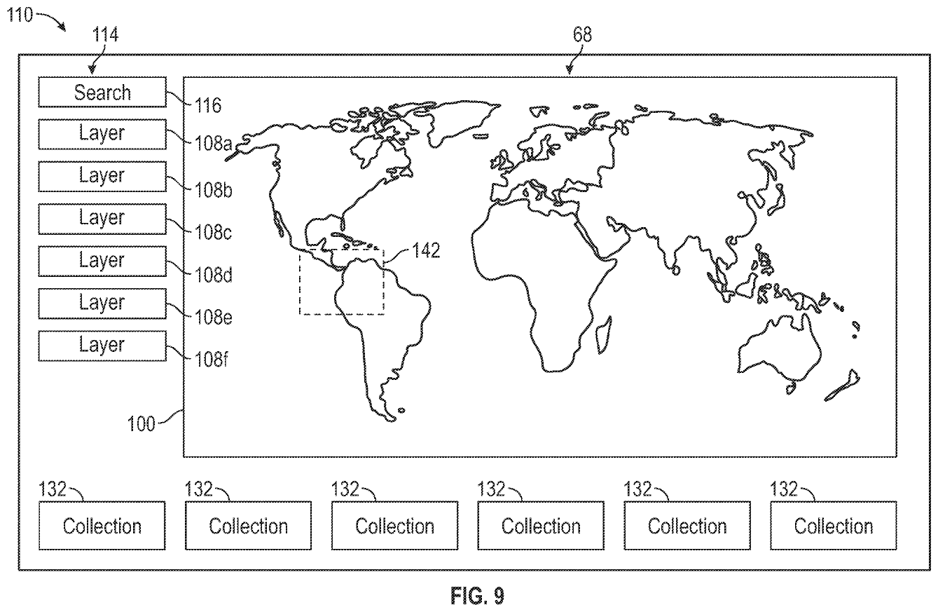

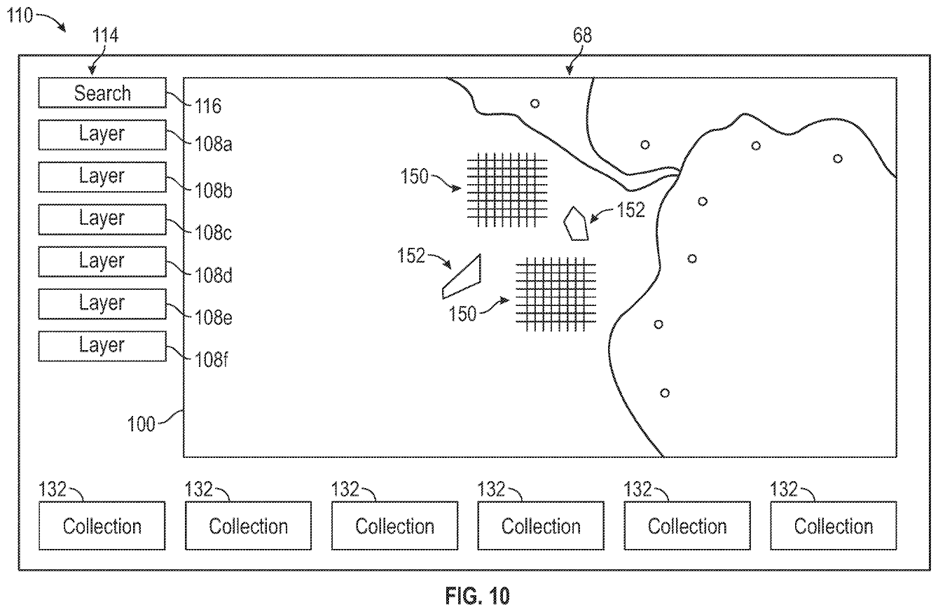

As described herein, the geographic data visualization 68 may be an interactive map 100. In some embodiments, the interactive map 100 may be capable of zooming (e.g., zooming in or zooming out), panning, rotating, tilting, changing illustrated map details (e.g., adding or removing vegetation, buildings and structures, etc.), or otherwise adjusting a currently displayed geographic region. To illustrate this, FIG. 9 shows an interactive window 110 that includes a fourth example of the geographic data visualization 68. As shown, the interactive window includes an inset window 142. In general, the inset window 142 may correspond to an area within the interactive window 110 that a user has selected for monitoring. To facilitate the user viewing the region, the interactive window 110 may zoom-in to show the region within the inset window 142. This is further illustrated in FIG. 10, which shows an interactive window 110 that includes a fifth example of the geographic data visualization 68 after zooming in relative to FIG. 9. As shown in the illustrated embodiment, the geographic data visualization 68 displays a 2D seismic data visualizations 150 and 3D seismic data visualizations 152. In some embodiments, the geographic data visualization 68 may be configured to show certain visualizations (e.g., the 2D seismic data visualizations 150, the 3D seismic data visualizations 152, or other visualizations associated with different categories or layers) when the interactive window 110 is zoomed in when a particular range.

As shown, the interactive window 110 includes a search and filter window 114. In a general similar manner as described with respect to FIG. 6, the search and filter window 114 includes one or more selectable features and/or interactive features that enable a user to tailor the amount and/or type of data displayed on the geographic data visualization 68. For example the search and filter window 114 includes a first data layer 108a, a second data layer 108b, a third data layer 108c, a fourth data layer 108d, a fifth data layer 108e, and a sixth data layer 108f. As described herein, each data layer may correspond to a particular category or attribute determined by the processor during at least one of blocks 80, 82, 84, 86, or a combination thereof. Additionally, the interactive window 110 includes multiple collection cards 132 that may provide a visual representation of the resource collections 70 associated with the inset 140 selected by the user and described with respect to FIG. 9.

In embodiments where there may be multiple resources that correspond to an area (e.g., a geographic area), the processor 30 may determine to prioritize displaying certain resource visualizations over others. In this way, the processor 30 may reduce display too much information, such that it may be difficult for the user to analyze the geographic data visualization 68, and this may also reduce computational resources of the data discovery and transformation system 12 as it does not need to generate as many resource visualizations for a particular area. In general, the prioritization rules may be based on the currently selected layers, user preferences (e.g., indicating that certain resource types be prioritized over other resource types), the relative amounts of different resource types (e.g., prioritize displaying more common resource types or less common resource types), or a combination thereof. For example, the processor 30 may determine a first amount of resource data 60 corresponding to the first category. Then, the processor 30 may determine a second amount of resource data 60 corresponding to the second category Further, the processor 30 may determine a subset (e.g., one or more visual resource representations) to display based on a comparison of the first amount to the second amount. For example, the processor 30 may determine to show the visual resource representations corresponding to the most common resource type or the least common resource type.

While the embodiments set forth in this disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A method comprising:
receiving resource data from a plurality of sources;
determining a location data associated with each resource data from the plurality of sources;
receiving criteria data corresponding to a user accessing the resource data; and
generating a geographic data visualization of the resource data based on the location data and the criteria data, wherein the geographic data visualization comprises a plurality of visual resource representations indicative of at least a portion of the resource data.

2. The method of claim 1, wherein generating the geographic data visualization of the resource data comprises:
identifying metadata associated with resource data;
determining a plurality of resource types based on the metadata; and
categorizing the resource data based on the plurality of resource types.

3. The method of claim 1, wherein generating the geographic data visualization of the resource data comprises determining a ranking criterion associated with the resource data based on the criteria data.

4. The method of claim 1, wherein generating the geographic data visualization based on the criteria data and the location comprises:
generating the geographic data visualization configured to display the plurality of visual resource representations;
determining a subset of the geographic data visualizations to display on the geographic visualization based on the criteria data; and
updating the geographic data visualization to display the subset of the geographic data visualizations.

5. The method of claim 1, wherein the resource data comprises geologic data.

6. The method of claim 1, wherein the resource data comprises non-geologic data.

7. The method of claim 1, wherein the criteria data indicates a category of the resource data, a subcategory of the resource data, or both.

8. The method of claim 1, wherein the geographic data visualization comprises a plurality of visual resource collection representations, wherein the plurality of visual resource collection representations are associated with one or more combinations of the plurality resource data.

9. The method of claim 1, wherein the geographic data visualization comprises one or more domain data visualizations.

10. A method, comprising:
receiving resource data from a plurality of sources;
determining location data associated with the resource data from the plurality of sources;
generating a geographic data visualization of the resource data based on the location data, wherein the geographic data visualization comprises a plurality of visual resource representations indicative of at least a portion of the resource data;
receiving criteria data indicating a user accessing the geographic data visualization;
determining one or more visual resource representations of the plurality of visual resource representations to display on the geographic data visualization based on the criteria data; and
updating the geographic data visualization based on the one or more visual resource representations of the plurality of visual resource representations.

11. The method of claim 10, wherein determining the one or more visual resource representations of the plurality of visual resource representation, comprises:
determining a subset of the plurality of visual resource representations based on the criteria data;
displaying the subset of the plurality of visual resource representations on the geographic data visualization in response to determining the subset.

12. The method of claim 11, wherein displaying the subset of the plurality of visual resource representations on the geographic data in response to determining the subset comprises:
determining a relevance score corresponding to resource data corresponding to the plurality of resource representations;
determining the subset based on the resource data having a relevance score that exceeds a threshold score.

13. The method of claim 10, wherein the criteria data indicates infrastructure data associated with an enterprise.

14. The method of claim 10, wherein the criteria data indicates a role of the user within an enterprise.

15. The method of claim 10, wherein the criteria data indicates a category of the resource data, a subcategory of the resource data, or both.

16. The system of claim 10, wherein the criteria data comprises one or more search terms provided as input.

17. A system, comprising:
one or more processors; and
a memory storing instructions that, when executed by the one or more processors, are configured to cause the one or more processors to perform operations comprising:
receiving resource data from a plurality of sources;
determining a location data associated with each resource data from the plurality of sources;
receiving criteria data corresponding to a user accessing the resource data; and
generating a geographic data visualization of the resource data based on the location data and the criteria data, wherein the geographic data visualization comprises a plurality of visual resource representations indicative of at least a portion of the resource data.

18. The system of claim 17, wherein generating the geographic visualization comprises adjusting a visual indication associated with the one or more of the plurality visual representations, wherein the visual indication indicates a relevance of the one or more of the plurality of the visual resource representations to the user based on the criteria data.

19. The system of claim 17, wherein resource data comprises wells, seismic 2D, seismic 3D, well logs, basins, fields, prospects, pipelines, power plants, refineries

20. The system of claim 17, wherein the instructions, when executed by the one or more processors, are configured to cause the one or more processors to perform operations comprising:
determining a plurality of categories corresponding to each resource data, the plurality of categories comprising a first category and a second category;
determining a first amount of resource data corresponding to the first category;
determining a second amount of resource data corresponding to the second category; and
determining the one or more visual resource representations of the plurality of visual resource representations to display based on a comparison of the first amount to the second amount.
